(19) United States
(12) Patent Application Publication
(10) Pub. No.: US 2002/0044807 A1
(43) Pub. Date: Apr. 18, 2002

(54) Image forming apparatus

(76) Inventors: Tadao Uehara, Hyogo (JP); Shohji Hayashi, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/973,771

(22) Filed: Oct. 11, 2001

(30) Foreign Application Priority Data
Oct. 13, 2000 (JP) 2000-313287 (JP)
Jan. 15, 2001 (JP) 2001-005946 (JP)

(51) Int. Cl. G03G 15/20

(52) U.S. Cl. 399/333; 432/60; 219/216; 399/329

(57) ABSTRACT

An image forming apparatus of the present invention includes a heat roller, a fixing roller, a press roller pressed against the fixing roller, and an endless belt passed over the heat roller and fixing roller. The surface of the press roller and that of the fixing roller have hardness of 70 or above and hardness of 60 or above, respectively, in terms of ASKER-C hardness. This successfully prevents a recording medium from wrapping around the belt and jamming a path or creasing.

### BACKGROUND OF THE INVENTION

1. Field of the Invention

The present invention relates to a copier, laser printer, facsimile apparatus or similar image forming apparatus.

2. Description of the Background Art

Japanese Patent Laid-Open Publication No. 5-27623, for example, discloses an image forming apparatus including a fixing device generally made up of a heat roller, a fixing roller, an endless belt passed over the two rollers, a press roller pressed against the fixing roller with the intermediary of the belt, and a tension roller for applying tension to the belt. A paper sheet or similar recording medium carrying a toner image thereon is conveyed via a nip between the press roller and the belt, so that the toner image is fixed on the paper sheet. The heat roller or the press roller accommodates a halogen lamp or similar heater. A coating roller coats silicone oil on the belt in order to promote parting of the paper sheet from the belt after fixation. The problem with this type of fixing device is that the paper sheet is apt to wrap around the belt or crease, resulting in defective conveyance.

Technologies relating to the present invention are also disclosed in, e.g., Japanese Patent Laid-Open publication Nos. 10-307501 and 2000-194225.

### SUMMARY OF THE INVENTION

It is therefore an object of the present invention to provide an image forming apparatus that insures desirable conveyance of a recording medium by preventing the recording medium from wrapping around a belt or creasing.

An image forming apparatus of the present invention includes an apparatus body, a heat roller, a fixing roller, a press roller pressed against the fixing roller, and an endless belt passed over the heat roller and fixing roller and nipped between the fixing roller and press roller. The press roller has a surface whose hardness is 70 or above in terms of ASKER-C hardness while the fixing roller has a surface whose hardness is 60 or above in terms of ASKER-C hardness.

### BRIEF DESCRIPTION OF THE DRAWINGS

The above and other objects, features and advantages of the present invention will become more apparent from the following detailed description taken with the accompanying drawings in which:

FIG. 1 is a section showing an image forming apparatus embodying the present invention;

FIG. 2 is a view demonstrating how a recording medium wraps around a belt in a conventional image forming apparatus of the same type as the illustrative embodiment; and

FIG. 3 is a table listing experimental results relating to the hardness of a fixing roller and that of a press roller.

### DESCRIPTION OF THE PREFERRED EMBODIMENT

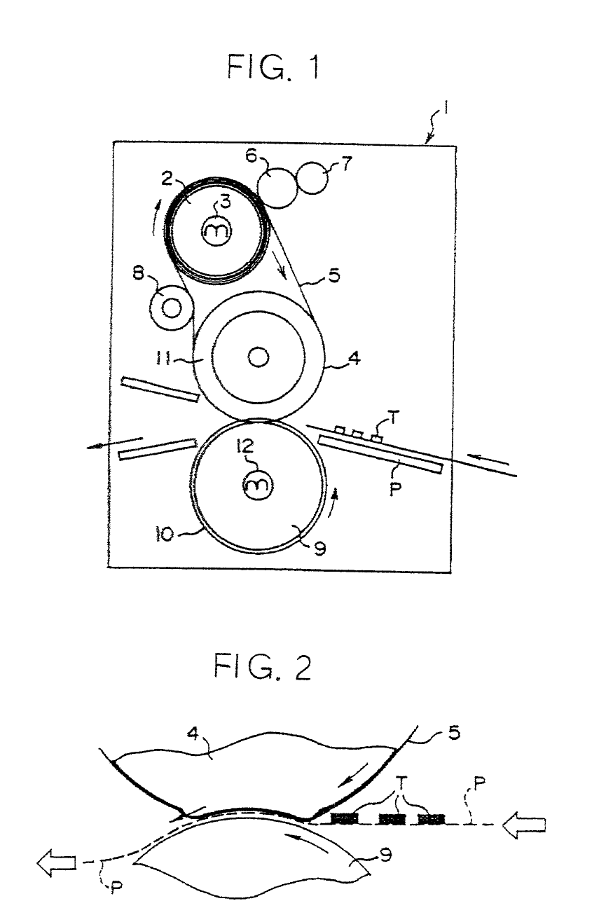

Referring to FIG. 1 of the drawings, an image forming apparatus embodying the present invention is shown and includes a casing 1. The casing 1 accommodates a heat roller 2, a fixing roller 4, an endless belt 5, a coating roller 6, an oil feed roller 7, a tension roller 8, and a press roller 9. A heater 3 is disposed in the heat roller 2. A rubber layer 11 covers the surface of the fixing roller 4. The belt 5 is passed over the heat roller 2 and fixing roller 4. The coating roller 6 coats oil on the surface of the belt 5 while the oil feed roller 7 feeds the oil to the coating roller 6. The tension roller 8 applies tension to the belt 5. A rubber layer 10 is formed on the surface of the press roller 9. A heater 12 is disposed in the press roller 9. The fixing roller 4 and press roller 9 are pressed against each other with the intermediary of the belt 5. The tension roller 8 is positioned downstream of the coating roller 6 in the direction of movement of the belt 5 so as not to effect the coating of the oil.

The belt 5 has a base formed of polyimide resin or SUS (chrome stainless steel as prescribed by JIS (Japanese Industrial Standards)), nickel or similar metal. A silicone rubber layer covers the surface of the base and plays the role of a parting layer. The rubber layer 10 of the press roller 9 has hardness of 70 or above in terms of ASKER-C hardness. The rubber layer 11 of the fixing roller 4 has hardness of 60 or above in terms of ASKER-C hardness.

In operation, the heat roller 2 heats the belt 5 in contact with the belt 5, which is running in a direction indicated by an arrow in FIG. 1. A paper sheet or similar recording medium P carrying a toner image T thereon arrives at a nip between the fixing roller 4 and press roller 9. The belt 5 and press roller 9 press the paper sheet P therebetween with the result that the toner image T is fixed on the paper sheet P.

FIG. 2 shows how the paper sheet P wraps around the belt 5 or creases in a conventional image forming apparatus of the same type as the illustrative embodiment. As shown, the paper sheet P moved away from the nip between the fixing roller 4 and the press roller 9 warps upward, as indicated by a dashed line in FIG. 2. As a result, the paper sheet P wraps around the belt 5. The paper sheet P will therefore not wrap around the belt 5 if it moves away from the above nip in such a manner as to hang down.

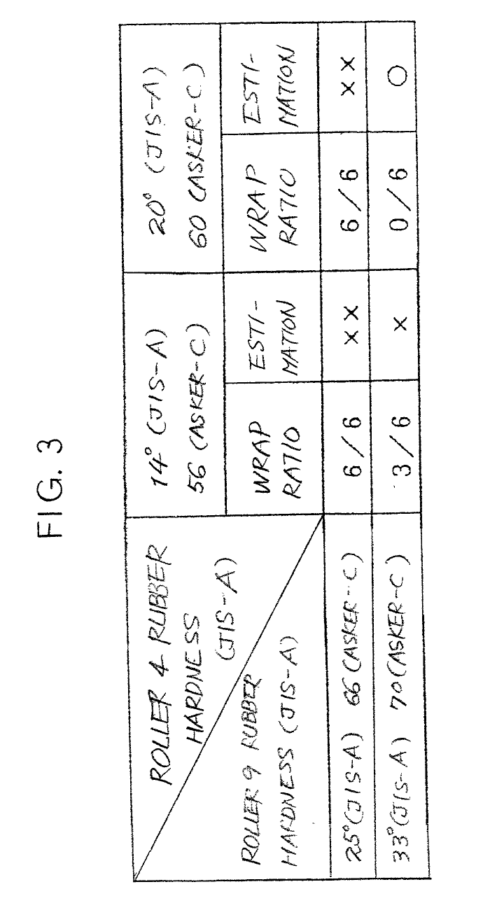

A series of studies and experiments showed that the hardness of the fixing roller 4 or that of the press roller 9 was the key to the above-described desirable movement of the belt 5. Specifically, it was found that the rubber surface of the fixing roller 4 and that of the press roller 9 should preferably have hardness of 70 or above and hardness of 60 or above, respectively, in terms of ASKER-C hardness. FIG. 3 lists the results of experiments relating to the hardness of the fixing roller 4 and that of the press roller 9.

In FIG. 3, a column “Wrap Ratio” refers to the number of times of wrapping occurred for six times of testing. In a column “Estimation”, a circle, a cross and crosses respectively show that no wrapping occurred, that some wrapping occurred, and that wrapping occurred every time. For the test, the fixing roller 4 and press roller 9 each were provided with a diameter of 40 mm. The pressure of the press roller 9 acting on the fixing roller 4 was so adjusted as to provide the nip with a length of about 8 mm in the direction of paper conveyance. The results shown in FIG. 3 were also obtained when the length of the above nip was 7.5 mm and 8.5 mm.

It should be noted that the image forming apparatus of the present invention may, of course, be implemented as a color image forming apparatus.

In summary, it will be seen that the present invention provides an image forming apparatus capable of improving the conveyance of a paper sheet by preventing the paper sheet from wrapping around a belt and jamming a conveyance path or creasing.

Various modifications will become possible for those skilled in the art after receiving the teachings of the present disclosure without departing from the scope thereof.

What is claimed is:

1. An image forming apparatus comprising:
an apparatus body;
a heat roller;
a fixing roller;
a press roller pressed against said fixing roller; and
an endless belt passed over said heat roller and said fixing roller and nipped between said fixing roller and said press roller;
wherein said press roller has a surface whose hardness is 70 or above in terms of ASKER-C hardness while said fixing roller has a surface whose hardness is 60 or above in terms of ASKER-C hardness.

2. The apparatus as claimed in claim 1, wherein the surface of said press roller and the surface of said fixing roller each comprise a rubber layer.

3. The apparatus as claimed in claim 2, wherein said apparatus comprises a color image forming apparatus.

4. The apparatus as claimed in claim 1, wherein said apparatus comprises a color image forming apparatus.
